(19) United States
(12) Patent Application Publication
(10) Pub. No.: US 2010/0107515 A1
(43) Pub. Date: May 6, 2010

(54) BARRIER AND METHOD FOR OBSTRUCTING PASSAGE OF TERMITES ACROSS THE SURFACE OF A STRUCTURE

(76) Inventor: James Carter Harrington, Hawthorne, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 12/684,066

(22) Filed: Jan. 7, 2010

Related U.S. Application Data
(63) Continuation of application No. 11/015,057, filed on Dec. 16, 2004, now abandoned.

(51) Int. Cl. E04B 1/72; A01M 1/14

(52) U.S. Cl. 52/101; 43/114; 52/741.3

(57) ABSTRACT

A barrier and a method to bar the passage of termites across the surface of a structure is provided, the barrier being applied to the surface of the structure and comprising a sticky adhesive substance capable of obstructing and entrapping termites which venture onto the surface of the adhesive.

### BACKGROUND OF THE INVENTION

The invention relates generally to the prevention of damage to wood structures and products by subterranean termites, and more particularly to a new and improved barrier and a method to bar the passage of termites across the surface of a structure.

Infestation and destruction of wooden components of above-ground structures by subterranean termites is a problem frequently encountered. Subterranean termites, which forage from a colony in the soil, may exit their tunnels in the soil to reach above-ground food sources by constructing closed earthen tunnels that extend from the soil to higher levels. Where the infested structure is a house, such tunnels are typically observed within dark crawl spaces of the interior of the house and less frequently on the outside of the house, because termites normally strive to avoid light. Most such tunnels are not self-supporting, but are attached to an existing structure such as a concrete foundation wall or a drain pipe in contact with the soil, and are frequently visible. However, sometimes subterranean termites will travel by making their tunnels in cracks in the structure's foundation and may be difficult to detect.

Once it has been determined that subterranean termites have infested a wood structure, a common known treatment method is the broad application of an insecticide on top of the soil or injected into the soil. As the exact location of the termite colony or their tunnels in the soil is generally not known or discernable, the soil is usually saturated with insecticide in the hope that some insecticide will find its mark. This method frequently results in the use of excessive amounts of insecticide, and, even so, may provide no guarantee of effective treatment.

Damage prevention methods can also include chemical barriers and physical barriers. A typical chemical barrier used in structural fabrication is the pretreatment of the soil under the structure prior to fabrication. Again, this treatment introduces into the environment large amounts of toxic material in the hope of blocking all access to termites from under the structure. Physical barriers may include metal shields with single or multiple surfaces, attached to the foundation, to block termite travel to the food source, which is typically an above-ground wooden structure. Another physical barrier requires placement of uniform sized particles of sand that are too large for a termite to grasp with its mandibles, thus providing a barrier to passage. This barrier can be easily disturbed by tradespeople working in the crawl space or the vicinity of the structure, and must be constantly maintained to remain effective.

An additional well known method for simply capturing vermin which infest a structure may be provided by a “glue board” which comprises a rectangular piece of cardboard or paper to which a highly adhesive substance is smeared over one surface. The adhesive substance is often scented to provide a lure to vermin and insects, and the glue boards are typically placed in an undisturbed portion of a structure's floor surface where they act as a lure to foraging insects and vermin. Thus scattered about on a horizontal surface, such glue boards are not configured to present a continuous barrier to the movement of insects or vermin across the surface, but are merely arranged to trap those that might be attracted to, or accidentally wander across, the glue board.

In light of the potential for long term negative effects from exposure to toxic compounds, other treatment approaches which reduce the total amount of insecticide used are desirable when providing protection against termite infestation. These needs, and others, are addressed by the present invention.

### SUMMARY OF THE INVENTION

In one aspect, the invention includes a pressure sensitive adhesive such as a sticky material or glue, applied on the interior of a house or structure, typically within the crawl space beneath the house. The adhesive may be applied in a substantially continuous band to the surface of concrete foundations, concrete piers, and other non-wood items which project from the soil to support or service the structure. The band of adhesive is optimally placed so as to provide a substantially continuous barrier between the wooden superstructure and the soil. Termites using such a surface as a support for their tunnel upwards to the food source will tend to become stuck on the sticky barrier in the process of constructing the tunnel. Ultimately, the adhesive surface disrupts the construction of the tunnel and, hence, travel of the termites to the food source.

In a further aspect, the invention includes a method of obstructing the upward movement of termites upon a generally vertical structure having an interior surface and an exterior surface. In one aspect the method includes applying to the interior surface an elongate barrier having a generally horizontal orientation, wherein the barrier presents an exposed adhesive surface adapted to entrap termites coming into contact with it. In another aspect, the elongate barrier is applied to the inside surface of the structure so as to extend substantially continuously across the full horizontal extent of the surface. In a further aspect, the barrier may comprise a flowable adhesive substance capable of being applied from a storage container under pressure. In yet another aspect, the barrier may include a reinforcing sheet adapted to facilitate application and removal of the barrier.

In further aspects, the invention includes a method of installing a barrier for obstructing the passage of termites across the surface of a generally vertical structure having an interior and an exterior surface. In one aspect, the barrier comprises a flowable adhesive substance adapted to entrap termites coming into contact therewith, and the method of installation comprises spraying the adhesive substance, under pressure, onto the interior surface of the structure such that the adhesive substance forms an elongate strip. The strip will optimally have a generally horizontal orientation and will extend substantially continuously across the entire extent of the interior surface of the structure. In yet a further aspect, a further method of installing a barrier is disclosed. In this aspect, the barrier comprises an adhesive substance adapted to entrap termites coming into contact with it and configured to have an elongate form with a first side and a second side. The barrier is initially laminated between a first and a second sheet of release paper. The method of installation includes removing a length of the first sheet of release paper to expose a length of the first side of the adhesive substance, applying the exposed length of the first side of the adhesive substance to the interior surface of the structure; and removing a length of the second sheet of release paper to expose a length of the second side of the adhesive substance. In yet a further aspect, the method of installation includes use of a barrier which comprises a first adhesive substance and a reinforcing sheet having one side coated in structural adhesive and the other attached to the first adhesive substance. The resulting assembly is initially laminated between a first and a second sheet of release paper. The method of installation includes removing a length of the first sheet of release paper to expose a length of the coated reinforcing sheet, applying the exposed length of the coated reinforcing sheet to the interior surface of the structure so that the second adhesive substance adheres the reinforcing sheet to the structure; and removing a length of the second sheet of release paper so that a length of the first adhesive substance is exposed.

These and other aspects and advantages of the invention will become apparent from the following detailed description and the accompanying drawings, which illustrate by way of example the features of the invention.

### BRIEF DESCRIPTION OF THE DRAWINGS

FIG. 1 is a schematic view, partly in section, of a crawl space under a structure showing typical surfaces across which termites might construct tunnels or passageways from the soil, and exemplifies aspects of the barrier of the present invention.

FIG. 2 is an enlarged sectional view of the barrier shown in FIG. 1, exemplifying aspects of one embodiment of the barrier of the present invention.

FIG. 3 is an enlarged sectional view of the barrier shown in FIG. 1, exemplifying aspects of a further embodiment of the present invention.

FIG. 4 is a sectional view exemplifying aspects of one embodiment for the construction, storage and installation of the barrier of the present invention.

FIG. 5 is a sectional view exemplifying aspects of a further embodiment for the construction, storage and installation of the barrier of the present invention.

FIG. 6 is a schematic perspective view exemplifying aspects of the installation of the barriers shown in FIGS. 4 and 5.

### DETAILED DESCRIPTION OF THE INVENTION

Referring now to the drawings, for purposes of illustration, there are shown various embodiments of the present invention, specifically, a barrier and a method for obstructing passage of termites across the surface of a structure.

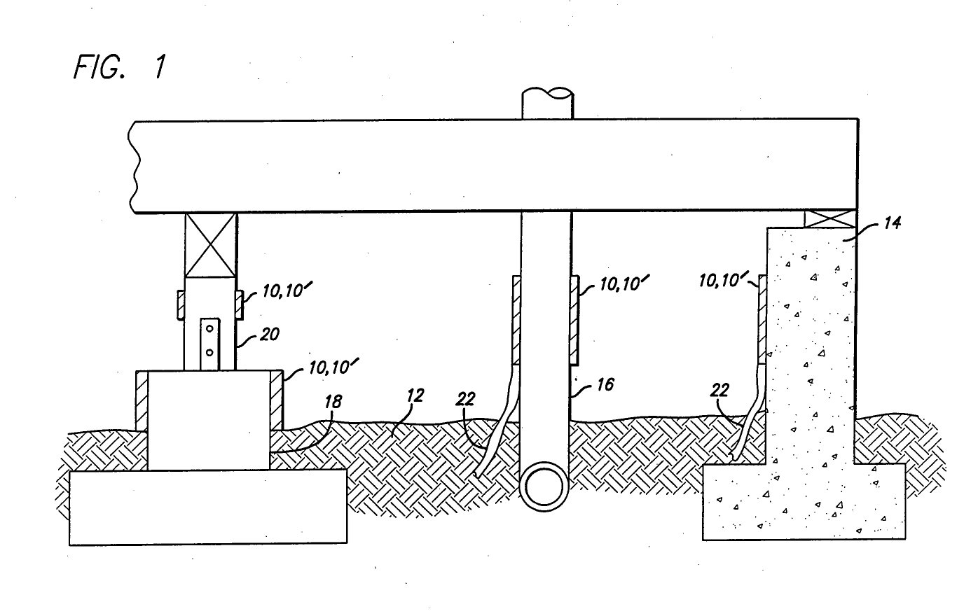

Referring to FIG. 1, there is exemplified an adhesive barrier 10, 10′ which has been applied to surfaces of objects typically encountered above the soil 12 in a building crawl space. The adhesive barrier may be applied as a substantially continuous band along the face of a foundation 14 or other constructional elements such as a conduit 16, a pier 18, a post 20, and the like, protruding from or existing above the soil 12. It will be appreciated that, for maximum effect, all potential paths for termite tunnels 22 from the soil toward the upper levels of the structure where wooden elements are located should be sealed off by the barrier 10, 10′.

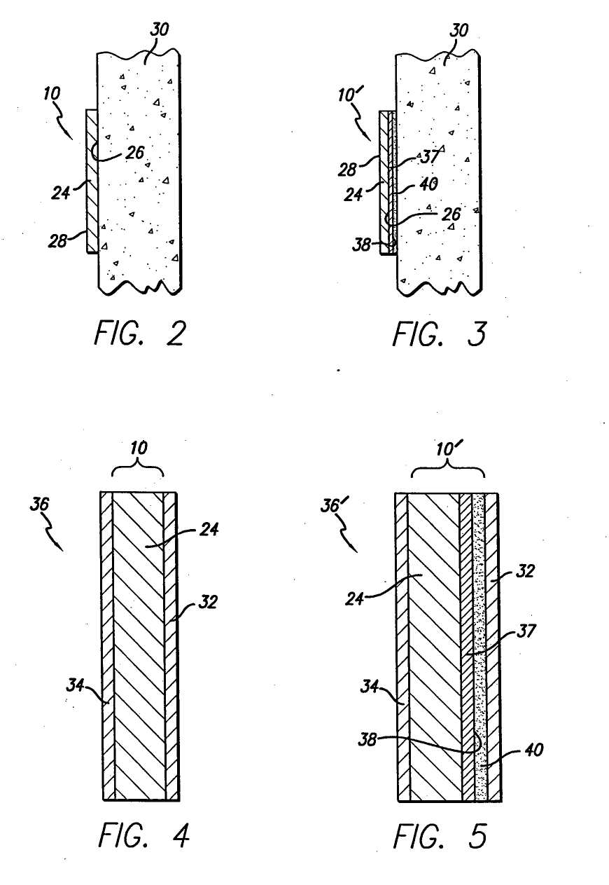

As exemplified in FIG. 2, in one embodiment of the barrier 10, the barrier comprises an adhesive substance 24 adapted to adhere, on an internal surface 26, to a selected structure 30; on the opposing external surface 28, the barrier is adapted to present an exposed sticky adhesive surface capable of entrapping termites and preventing their passage across the surface. The substance 24 is further adapted to maintain, for as long as possible, the sticky characteristic of its exposed surface 28. It has been found that a suitable substance for this purpose is the same type of glues typically used on glue boards, which may be provided, for instance, on the glue board manufactured by the Atlantic Paste & Glue Co., Inc. of 4-53rd Street, Brooklyn, N.Y. 11232. It will be appreciated that, once applied, the effective life of the adhesive substance 24 will be enhanced by preventing activities and environmental conditions in the vicinity of the barrier that may generate a particulate dust which may adhere to and contaminate the exposed surface 28 of the barrier. However, the nature of the barrier allows for visual and tactile inspection of its surface condition. When the exposed surface 28 of the barrier becomes ineffective by losing stickiness, another layer of the adhesive barrier may be applied over the existing layer, or the existing layer may be removed and replaced by a fresh layer.

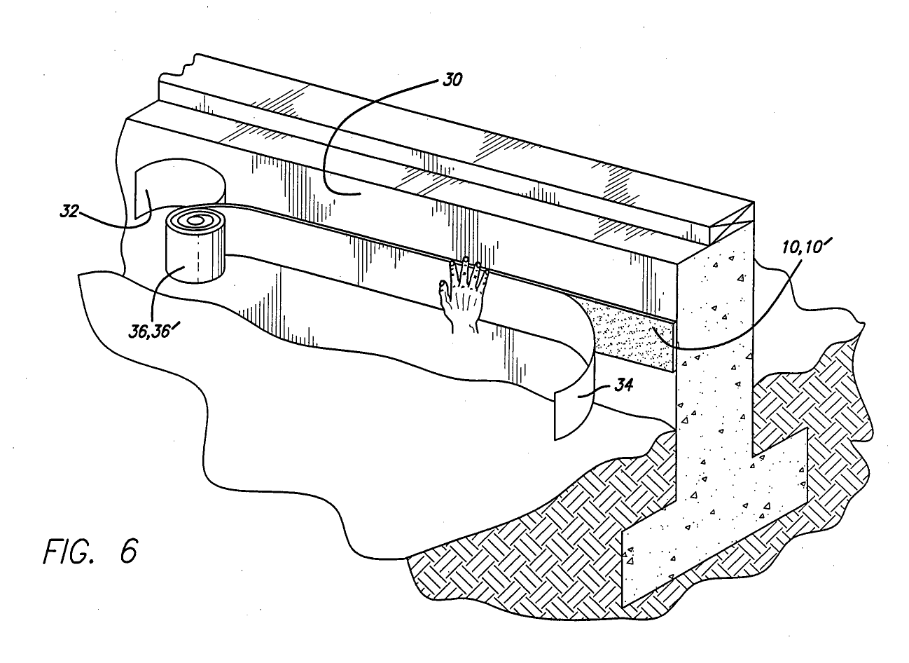

In one aspect relating to installation of the adhesive barrier to the surface of the structure, the adhesive substance 24 intended to form the barrier may be provided in flowable form and adapted to be applied to the surface with a sprayer, similar to an airless paint sprayer, or by brush or from a compressible tube. In another aspect relating to installation of the barrier, a strip of the substance 24 intended to form the barrier may, prior to installation, be laminated on either side by a first release paper 32 and a second release paper 34, as exemplified in FIG. 4. The resulting kit or assembly 36 may be coiled up on itself or rolled onto a mandrel, thus facilitating storage, transportation, and installation. As exemplified in FIG. 6, upon installation, a length of the first release paper 32 may be removed, exposing a length of the inner surface 26 of the adhesive substance 24 which may be applied to the selected surface of the structure 30 by applying an even hand pressure to the second release paper 34. When the desired length of substance 24 has been applied to the structure 30, the roll of barrier assembly 36 my be cut, and the second release paper 34 may be removed from the substance 24 adhering to the structure, thus leaving the substance 24 alone adhering to the structure and forming the barrier 10.

In an alternative embodiment, exemplified in FIG. 3, an adhesive barrier 10′ may include an elongate strip of the same barrier substance 24 as the previously described embodiment, to which is attached on the interior side 26 of the substance a reinforcing sheet 37. The reinforcing sheet, which may be made of paper, or synthetic material, or flexible fabric, may be treated on its interior side 38 with a structural adhesive 40 adapted to adhere to a structure 30. Thus, a barrier 10′ may be provided in which a first adhesive substance 24 is selected for its ability to provide a barrier to the passage of termites, and a second adhesive coating 40 is selected for its ability to adhere the reinforcing sheet 37 to a structure. By separating the structural adhesive 40 from the barrier adhesive 24 into two components by a reinforcing sheet 37, use may be made of different types of adhesive for the different functions of adhering to the support structure on the one hand, and providing a barrier to termites on the other hand. Such separation of adhesive types by a reinforcing sheet 36 may also facilitate eventual removal of the barrier from the structure in that the structural adhesive may be adapted for subsequent removal by being peeled away from the structure, and the reinforcing sheet may be adapted to facilitate peeling away from the structure while maintaining the barrier adhesive 24 in an integral form, thereby facilitating tidy disposal of the barrier adhesive. For purposes of storing, transporting, and applying the barrier of the presently described embodiment, the barrier 10′ may be incorporated into an assembly 36′, exemplified in FIG. 5, wherein a first release paper 32 may be removably applied to the structural adhesive 40, and a second release paper 34 may be removably applied to the barrier adhesive 24. The resulting kit or assembly 36′ may be coiled on itself or rolled on a mandrel to facilitate storage, transportation, and installation.

Installation of the barrier 10′ exemplified in FIG. 3 and included in the assembly 36′ exemplified in FIG. 5 may be similarly accomplished, as exemplified in FIG. 6, by removing a section of first release paper 32, thereby exposing the structural adhesive 40. The structural adhesive is pressed evenly against the selected structural surface 30 by applying pressure to the second release paper 34. Once the structural adhesive 40 is satisfactorily engaged with the structural surface, the second release paper 34 may be removed, leaving the barrier adhesive 24 exposed. For small areas requiring less than the full coiled length of material, the assembly 36′ can be cut at anytime during the installation.

In further embodiments of the present invention, a barrier to the progress of termites into a structure may be provided as follows. Where termites have infested the ground beneath a concrete slab which is to support a wooden structure, it is frequently found that if the slab develops cracks, termites may construct their earthen tunnels through the cracks and into the interior of the structure. Previously, in eradicating such termite infestations holes were drilled through the slab in the vicinity of the infestation to introduce toxic chemicals into the soil, by being pumped under pressure. In one further aspect of the invention, holes may be drilled in the slab and any termite tunnels in the soil may be destroyed; then, instead of introducing toxic chemicals, the adhesive substance 24 in flowable form and adapted to be applied with a sprayer, or under pressure in some other fashion, may be injected through the cracks and holes to introduce and to coat the entire region of the infestation, so as to provide a barrier to access to the interior of the structure.

Thus there is disclosed a conveniently applicable barrier and method for barring the progress of termites across the surface of structures which is relatively easy to manufacture, to apply, to remove, and which is free from toxic chemicals.

While several particular forms of the invention have been illustrated and described, it will be apparent that other modifications and improvements may be made without departing from the spirit and scope of the invention.

Accordingly, it is not intended that the invention be limited, except as by the appended claims.

We claim:

1. A method of obstructing the upward movement of termites upon a generally vertical structure having an interior surface and an exterior surface, said method comprising:
adhering to the interior surface an elongate barrier having a generally horizontal orientation, wherein the barrier presents an exposed adhesive surface adapted to entrap termites coming into contact therewith.

2. The method of claim 1, wherein the interior surface of the vertical structure extends horizontally continuously between a first end and a second end, and wherein the elongate barrier is adhered to the inside surface so as to extend substantially continuously between the first end and the second end.

3. The method of claim 1 wherein the barrier comprises a flowable adhesive substance capable of being applied from a storage container under pressure.

4. The method of claim 1 wherein the barrier comprises an adhesive substance adapted to permit temporary lamination between two release papers.

5. The method of claim 1 wherein the barrier further comprises a reinforcing sheet.

6. A method of installing a barrier for obstructing the passage of termites across the surface of a generally vertical structure having an interior and an exterior surface, the barrier comprising a flowable adhesive substance adapted to entrap termites coming into contact therewith, said method comprising:
spraying the adhesive substance, under pressure, onto the interior surface of the structure such that the adhesive substance forms an elongate strip.

7. The method of claim 6, wherein the spraying step is carried out so as to apply the adhesive substance to the interior surface in a generally horizontal orientation.

8. The method of claim 7 wherein the interior surface of the generally vertical structure extends continuously horizontally from a first end to a second end, and wherein the applying step is carried out so that the adhesive substance extends substantially continuously from the first end to the second end of the interior surface.

9. A method of installing a barrier for obstructing the passage of termites across the surface of a generally vertical structure having an interior and an exterior surface, the barrier comprising an adhesive substance adapted to entrap termites coming into contact therewith and configured to have an elongate form with a first side and a second side and being initially laminated between a first and a second sheet of release paper, said method comprising:
removing a length of the first sheet of release paper to expose a length of the first side of the adhesive substance;
applying the exposed length of the first side of the adhesive substance to the interior surface of the structure; and
removing a length of the second sheet of release paper to expose a length of the second side of the adhesive substance.

10. The method of claim 9 wherein the applying step is carried out so as to apply the adhesive substance to the interior surface of the structure in a generally horizontal orientation.

11. The method of claim 10, wherein the interior surface of the generally vertical structure extends continuously horizontally from a first end to a second end, and wherein the applying step is carried out so that the adhesive substance extends substantially continuously from the first end to the second end of the interior surface.

12. A method of installing a barrier for obstructing the passage of termites across the surface of a generally vertical structure having an interior and an exterior surface, the barrier comprising a first adhesive substance adapted to entrap termites coming into contact therewith and configured to have an elongate form with a first side and a second side, and a reinforcing sheet having a first side and a second side wherein the first side of the reinforcing sheet is adhered to the first side of the first adhesive substance and wherein the second side of the reinforcing sheet is coated with a second adhesive substance adapted to adhere to structural surfaces, the barrier being initially laminated between a first and a second sheet of release paper so that the first sheet of release paper covers the coated second side of the reinforcing sheet, and the second sheet of release paper covers the second side of the first adhesive substance, said method comprising:
removing a length of the first sheet of release paper to expose a length of the coated second side of the reinforcing sheet;
applying the exposed length of the coated second side of the reinforcing sheet to the interior surface of the structure so that the second adhesive substance adheres to the structure; and
removing a length of the second sheet of release paper so that a length of the first adhesive substance is exposed.

13. The method of claim 12 wherein the applying step is carried out so as to apply the reinforcing sheet to the interior surface of the structure in a generally horizontal orientation.

14. The method of claim 13, wherein the interior surface of the generally vertical structure extends continuously horizontally from a first end to a second end, wherein the applying step is carried out so that the reinforcing sheet extends substantially continuously from the first end to the second end of the interior surface.

15. A method of obstructing the passage of termites from the soil through a surface slab, the barrier comprising a flowable adhesive substance, said method comprising:
drilling holes in the surface slab and injecting the adhesive substance into the soil so as to form a barrier between the soil and the surface slab.

16. A kit for forming a barrier to the passage of termites across the surface of a structure, the kit comprising:
an elongate sheet of adhesive substance adapted to entrap termites coming into contact with it; and
a first and a second release paper laminating either side of the sheet of adhesive substance.

17. The kit of claim 16, wherein the kit is further formed into a roll adapted to facilitate storage and transport.

18. A kit for forming a barrier to the passage of termites across the surface of a structure, the kit comprising:
a first adhesive substance adapted to entrap termites coming into contact with it and configured to have an elongate form with a first side and a second side;
a reinforcing sheet having a first side and a second side, the first side of the reinforcing sheet being adhered to the first side of the first adhesive substance, the second side of the reinforcing sheet being coated with a second adhesive substance adapted to adhere to a generally vertical structure; and
a first and a second sheet of release paper adhering, respectively, to the coated second side of the reinforcing sheet and to the second side of the first adhesive substance.

19. The kit of claim 18, wherein the kit is further formed into a roll adapted to facilitate storage and transport.
